(19) United States
(12) Patent Application Publication
(10) Pub. No.: US 2018/0261919 A1
(43) Pub. Date: Sep. 13, 2018

(54) METHOD OF MANUFACTURING MAGNETIC SUBSTANCE AND METHOD OF MANUFACTURING WIRELESS COMMUNICATIONS ANTENNA INCLUDING THE SAME

(71) Applicant: SAMSUNG ELECTRO-MECHANICS CO., LTD., Suwon-si (KR)

(72) Inventors: Sung Nam CHO, Suwon-si (KR); Dae Young HWANG, Suwon-si (KR); Jung Young CHO, Suwon-si (KR); Hyun Do PARK, Suwon-si (KR)

(73) Assignee: SAMSUNG ELECTRO-MECHANICS CO., LTD., Suwon-si (KR)

(21) Appl. No.: 15/794,607

(22) Filed: Oct. 26, 2017

(30) Foreign Application Priority Data
Mar. 7, 2017 (KR) 10-2017-0028985

(51) Int. Cl. H01Q 7/06; H01F 41/16; H01F 41/04; H01Q 1/24

(52) U.S. Cl. CPC H01Q 7/06; H01Q 1/24; H01F 41/04; H01F 41/16

(57) ABSTRACT

A method of manufacturing a magnetic substance includes forming crack lines arranged in one direction on a magnetic sheet by crushing the magnetic sheet to divide the magnetic sheet by the crack lines; stacking the magnetic sheet with other magnetic sheets into layers; and press-processing the stacked magnetic sheets.

### CROSS-REFERENCE TO RELATED APPLICATIONS

This application claims the benefits under 35 USC 119(a) of Korean Patent Application No. 10-2017-0028985 filed on Mar. 7, 2017 in the Korean Intellectual Property Office, the entire disclosure of which is incorporated herein by reference for all purposes.

### BACKGROUND

### 1. Field

The following description relates to a method of manufacturing a magnetic substance and a method of manufacturing a wireless communications antenna including the same.

### 2. Description of Related Art

Wireless communications have a wide range of applications. In particular, a wireless communications antenna in a form of a coil, in connection with electronic approval, may be applied to various devices.

Mobile devices have recently employed a wireless communications antenna of a form of a spiral coil attached to a cover of the mobile device.

In addition, as a wearable device is widely used, demand for a wireless communications antenna suitable for the wearable device as well as the mobile device has increased.

The wireless communications antenna employed in the wearable device should satisfy requirements of a radiation direction and a radiation range for securing reliable data transmission and for user convenience. In addition, the wireless communications antenna mounted in the wearable device, which is implemented to have a relatively small size, should have mass production properties secured therein, according to miniaturization.

In order to satisfy characteristics of such a wireless communications antenna, a magnetic substance functioning as a core of the antenna and a method of manufacturing the same have been studied.

### SUMMARY

This Summary is provided to introduce a selection of concepts in a simplified form that are further described below in the Detailed Description. This Summary is not intended to identify key features or essential features of the claimed subject matter, nor is this Summary intended to be used as an aid in determining the scope of the claimed subject matter.

In one general aspect, there is provided a method of manufacturing a magnetic substance, the method including: forming crack lines arranged in one direction on a magnetic sheet by crushing the magnetic sheet to divide the magnetic sheet by the crack lines; stacking the magnetic sheet with other magnetic sheets into layers; and press-processing the stacked magnetic sheets.

The magnetic sheet may be divided into unit ribbons by the crack lines; and each of the unit ribbons has an aspect ratio of 1:6 to 1:9.

The aspect ratio may be an aspect ratio of a width to a length of each of the of unit ribbons.

The crack lines may have a pitch of 1.25 mm or more and 5 mm or less.

The method may further include, before the crushing of the magnetic sheet, forming an adhesive layer on one surface of the magnetic sheet.

In the stacking of the magnetic sheet, the magnetic sheet may be stacked so that a crack line of the magnetic sheet overlaps a crack line of an adjacent magnetic sheet of the other magnetic sheets.

In the stacking of the magnetic sheet, the magnetic sheet may be stacked so that a crack line of the magnetic sheet is offset from a crack line of an adjacent magnetic sheet of the other magnetic sheets.

In the stacking of the magnetic sheet, the magnetic sheet may be stacked so that a crack line of the magnetic sheet overlaps a crack line of an adjacent magnetic sheet of the other magnetic sheets and another crack line of the magnetic sheet is offset from the crack line of the adjacent magnetic sheet.

In the crushing of the magnetic sheet, the crack lines may be formed so that a pitch of the crack lines is uniform.

In the crushing of the magnetic sheet, the crack lines may be formed by applying a roller having protrusions to the magnetic sheet.

The protrusions of the roller may be formed linearly to be perpendicular to a direction in which the roller moves.

The protrusions of the roller may be formed parallel to an axis of rotation of the roller.

The method may further include stacking a resin layer to form an outer layer of the stacked magnetic sheets.

In another general aspect, there is provided a method of manufacturing a wireless communications antenna, the method including: forming crack lines arranged in one direction on a magnetic sheet by crushing the magnetic sheet to divide the magnetic sheet by crack lines; stacking the magnetic sheet with other magnetic sheets into layers; press-processing the stacked magnetic sheets; bonding a first substrate to a top surface of the stacked magnetic sheets and a second substrate to a bottom surface of the stacked magnetic sheets; and forming conductive vias configured to connect conductive patterns on the first substrate with conductive patterns on the second substrate.

In the stacking of the magnetic sheet, the magnetic sheet may be stacked so that the crack lines of the magnetic sheet overlap crack lines of an adjacent magnetic sheet of the other magnetic sheets.

In the stacking of the magnetic sheet, the magnetic sheet may be stacked so that crack lines of the magnetic sheet are offset from crack lines of an adjacent stacked magnetic sheet of the other magnetic sheets.

The crack lines may have a pitch of 1.25 mm or more and 5 mm or less.

The conductive patterns and the conductive vias may form a solenoid coil; and the one direction may be parallel to an axis of the solenoid coil.

The method may further include forming a reinforcing layer disposed between the first substrate and the second substrate, at an outer portion of the stacked magnetic sheets.

The method may further include stacking a resin layer to form an outer layer of the stacked magnetic sheets.

Other features and aspects will be apparent after an understanding of the following detailed description, drawings, and claims.

### BRIEF DESCRIPTION OF DRAWINGS

FIG. 1 is a perspective view illustrating an example in which a wearable device including a wireless communications antenna according to the present disclosure performs wireless communications.

FIG. 2 is an exploded perspective view illustrating main components of the wearable device of FIG. 1.

FIG. 3 is a front view of a wireless communications antenna according to an example embodiment in the present disclosure.

FIG. 4 is a cross-sectional view of the wireless communications antenna according to an example embodiment in the present disclosure.

FIG. 5 is a flowchart illustrating a method of manufacturing a magnetic substance according to an example embodiment in the present disclosure.

FIG. 6 is a process diagram illustrating the method of manufacturing a magnetic substance according to an example embodiment in the present disclosure.

FIG. 7 is a cross-sectional view of a magnetic substance according to an example embodiment in the present disclosure.

FIG. 8 is a cross-sectional view of a magnetic substance according to another example embodiment in the present disclosure.

FIG. 9 is a perspective view of a magnetic substance according to an example embodiment in the present disclosure.

FIG. 10 is a flowchart illustrating a method of manufacturing a wireless communications antenna according to an example embodiment in the present disclosure.

FIG. 11 is a graph illustrating a relationship between a shape anisotropy constant and an aspect ratio of a unit ribbon.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

As used herein, the term “and/or” includes any one and any combination of any two or more of the associated listed items.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. In addition, the use of the term “may” herein with respect to an example or embodiment, e.g., as to what an example or embodiment may include or implement, means that at least one example or embodiment exists where such a feature is included or implemented while all examples and embodiments are not limited thereto.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

Hereinafter, example embodiments of the present disclosure will be described in detail with reference to the accompanying drawings.

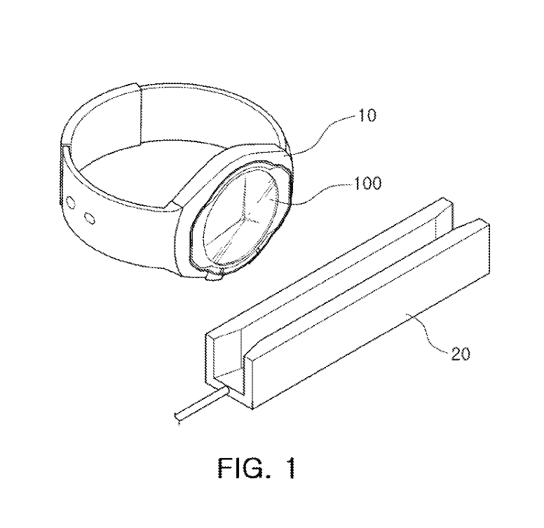

FIG. 1 is a perspective view illustrating an example in which a wearable device including a wireless communications antenna according to the present disclosure performs wireless communications.

The wearable device may be an electronic device which may be worn on a human body part such as an arm, a head, or the like, or may be fixed to a specific structure by a strap. Although FIG. 1 illustrates that the wearable device according to the present disclosure has a form of a wristwatch, the wearable device is not limited thereto.

The wireless communications antenna 100 may be included in the wearable device 10, and may form a magnetic field controlled by the wearable device 10. Specifically, the wireless communications antenna 100 may be operated as a transmitting coil, and may be magnetically coupled to a wireless signal receiver including a receiving coil to thereby wirelessly transmit information.

In FIG. 1, a magnetic card reader 20 is illustrated as the wireless signal receiver including the receiving coil. According to example embodiments, the wireless signal receiver may include the receiving coil. Various wireless signal receivers may be used in addition to the magnetic card reader 20.

The wireless communications antenna 100 may form a widespread magnetic field using the transmitting coil, and may be magnetically coupled to the magnetic card reader 20 even in a case in which a position or an angle of the receiving coil of the magnetic card reader 20 is changed. According to an example embodiment, the wireless communications antenna 100 may transmit data—e.g., card number data—intended to be transmitted to the magnetic card reader 20 by changing a direction of the magnetic field. In other words, the magnetic card reader 20 may generate the card number data using a change in a voltage across the receiving coil caused by the change in the magnetic field formed in the wireless communications antenna 100.

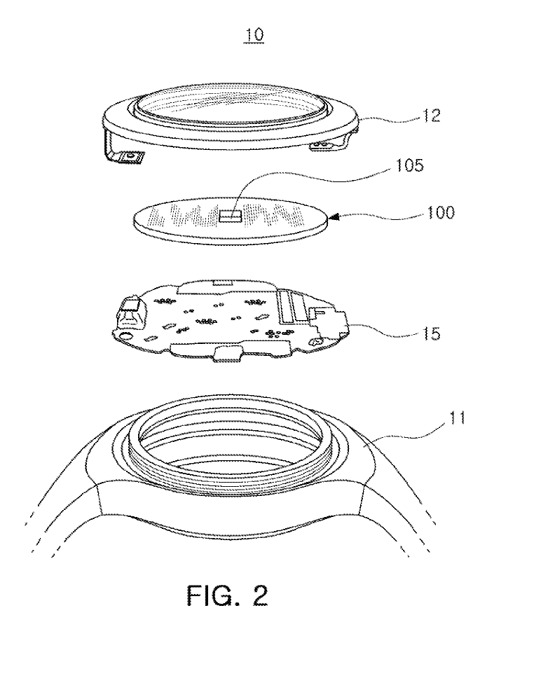

FIG. 2 is an exploded perspective view illustrating components of the wearable device of FIG. 1.

Referring to FIG. 2, the wearable device 10 may include a case 11, a display 12, a wireless communications antenna 100, and a main board 15. The display 12 may be disposed to face a front surface of the case 11, and may visualize an electronic signal to provide visual information to the user. In addition, although not illustrated in FIG. 2, the wearable device 10 may include a battery for supplying power.

The wireless communications antenna 100 may be applied with a driving signal from the main board 15 to form the magnetic field. That is, the wireless communications antenna 100, which is the transmitting coil, may radiate a magnetic pulse. In addition, the transmitting coil may be magnetically coupled to the wireless signal receiver including the receiving coil, to thereby wirelessly transmit information. Here, the information may be magnetic stripe data.

According to an example embodiment, the wearable device 10 may include an illuminance sensor sensing ambient light incident through the display 12. The wireless communications antenna 100 may be disposed below the display 12, and may include a hole 105 to expose the illuminance sensor to the ambient light.

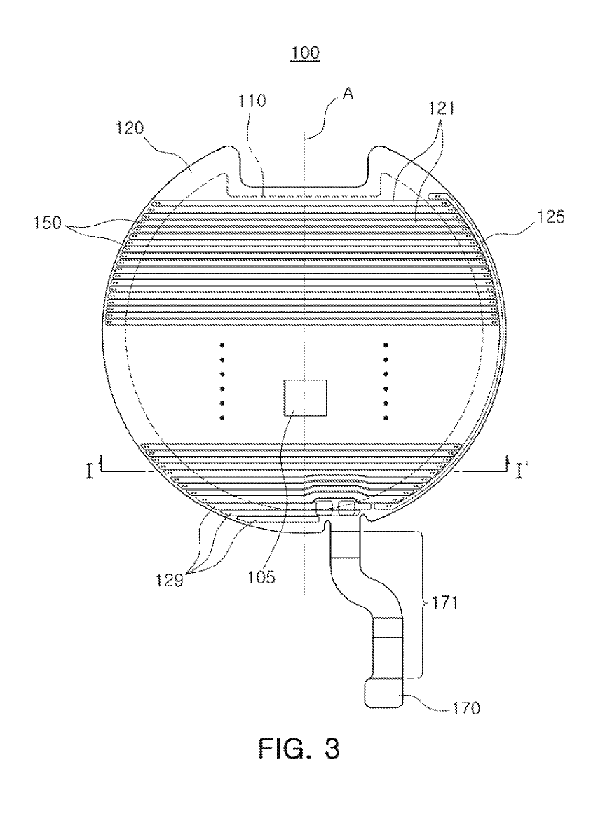

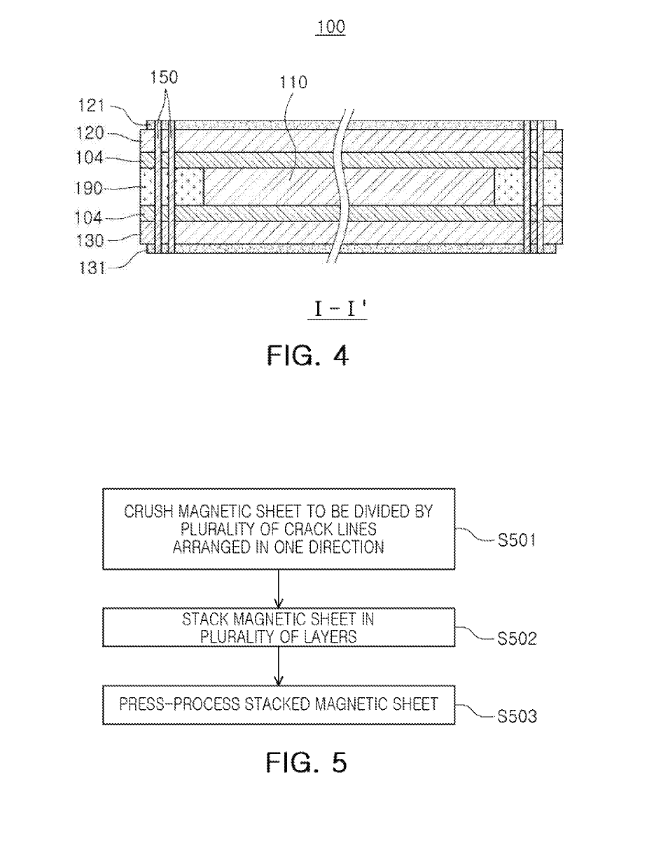

FIG. 3 is a front view of a wireless communications antenna according to an example embodiment in the present disclosure and FIG. 4 is a cross-sectional view of the wireless communications antenna according to an example embodiment in the present disclosure.

Referring to FIGS. 3 and 4, the wireless communications antenna according to an example embodiment may include a magnetic substance 110, a first substrate 120, a second substrate 130, and a plurality of conductive vias 150. In addition, the wireless communications antenna may further include a hole 105. Further, a reinforcing layer 190 may be disposed between the first substrate and the second substrate and disposed at an outer portion of the magnetic substance 110.

The first substrate 120 and the second substrate 130, which are thin film substrates, may be a flexible board such as a flexible printed circuit board (FPCB). However, the first substrate 120 and the second substrate 130 are not limited thereto. For example, the first substrate 120 and the second substrate 130 may have a circular shape, an oval shape, or a polygonal shape, and may have portions in which at least a portion thereof is depressed or protrudes as illustrated in FIG. 3.

A plurality of conductive patterns 121 and 131 may be formed on the first substrate 120 and the second substrate 130, respectively. In addition, the plurality of conductive vias 150 may be disposed in a region around the magnetic substance 110, and may connect the conductive pattern 121 of the first substrate 120 and the conductive pattern 131 of the second substrate 130 with each other. That is, one conductive pattern 121 formed on the first substrate 120 may be connected to one conductive pattern 131 formed on the second substrate 130, and one turn of a coil may be completed by such a connection. As illustrated in FIG. 3, one conductive pattern 121 on the first substrate 120 and one conductive pattern 131 on the second substrate 130 may be connected to each other by two conductive vias 150 to thereby prevent a short-circuit.

As such, a plurality of conductive patterns 121 on the first substrate 120 and a plurality of conductive patterns 131 on the second substrate 130 may be connected to each other by the plurality of conductive vias 150 to thereby form a solenoid coil.

Since the wireless communications antenna 100 according to the present disclosure includes the solenoid coil formed by the conductive patterns formed on the thin film substrate, and not by a wiring of a conventional wire form, the wireless communications antenna 100 may have a very thin thickness. Accordingly, the wireless communications antenna 100 may be advantageously thin compared to antennas including solenoid coils of a conventional wire form.

Meanwhile, since a material of the first substrate 120 and a material of the plurality of conductive patterns 121 are different from each other, the first substrate 120 and the plurality of conductive patterns 121 may have a difference in reflectivity for light. According to an example embodiment, the wireless communications antenna 100 may be disposed below the display 12 (FIG. 2), and light transmitting through the display may cause a shadow region on a screen of the display by the difference of such reflectivity.

In order to prevent an occurrence of such a shadow region, a dummy pattern 129 may be disposed on a region of the first substrate 120 on which the plurality of conductive patterns 121 are not disposed. The dummy pattern 129 may be formed of the same material as the plurality of conductive patterns 121 of the first substrate 120.

In addition, a lead pattern 125 may be disposed on the first substrate 120 to apply the driving signal to both ends of the solenoid coil. As illustrated in FIG. 3, the lead pattern 125 may be disposed on an outermost region of the first substrate 120, that is, an outer region of the plurality of conductive patterns.

In addition, the wireless communications antenna 100 may include a contact terminal 170. The contact terminal 170, which is a component for electrically connecting the main board 15 (FIG. 2) and the wireless communications antenna 100 with each other, may be disposed at one end of a lead part 171 protruding from the first substrate 120 or the second substrate 130.

The magnetic substance 110 may form a core of the solenoid coil, prevent an eddy current, and enhance the magnetic field formed by the solenoid coil. A shape of the magnetic substance 110 may be variously deformed according to a shape of the first substrate 120 and the second substrate 130, or may be variously deformed according to a length and an arrangement of the plurality of conductive patterns 121 and 131. For example, similar to the first substrate 120 and the second substrate 130, the magnetic substance 110 may have a circular shape, an oval shape, or a polygonal shape, and may have portions in which at least a portion thereof is depressed or protrudes. A material of the magnetic substance 110, a structure thereof, and a method of manufacturing the same will be described in more detail with reference to FIGS. 5 through 9.

Meanwhile, the first substrate 120 and the second substrate 130 may each respectively be attached to the magnetic substance 110 by an adhesive sheet 104. The adhesive sheet 104 may be an adhesive tape, and be formed by applying an adhesive or a resin having adhesive properties to a surface of the first and second substrates 120 and 130 or the magnetic substance 110.

A method of manufacturing a magnetic substance according to an example embodiment in the present disclosure will be described with reference to FIGS. 5 through 9.

Referring to a flowchart of FIG. 5, a method of manufacturing a magnetic substance according to an example embodiment in the present disclosure may include an operation (S501) of crushing a magnetic sheet to be divided by a plurality of crack lines arranged in one direction, an operation (S502) of stacking the magnetic sheet in a plurality of layers, and an operation (S503) of press-processing the stacked magnetic sheet.

The magnetic sheet may be obtained by pressing-molding a powder magnetic material, or sintering the powder magnetic material after pressing the power magnetic material. The magnetic sheet which is a soft magnetic material may be a thin plate metal ribbon having an amorphous structure or a nano-crystalline structure. Alternatively, the magnetic sheet may be formed of permalloy, which is a material having high permeability.

As the metal ribbon having the amorphous structure, a Fe-based or Co-based magnetic alloy may be used. As the Fe-based magnetic alloy, for example, a Fe—Si—B alloy may be used, and as content of a metal including Fe is high, saturation magnetic flux density is increased, but when the content of a Fe element is excessive, it is difficult to form the amorphous structure. Therefore, the content of Fe may be 70 to 90 atomic %, and when a sum of Si and B is in the range of 10 to 30 atomic %, the alloy may have the best amorphous forming ability. In order to prevent corrosion of such a basic composition, corrosion resistant elements such as Cr, Co, and the like may be added within 20 atomic %, and a small amount of other metal elements may be included to give other characteristics, as needed.

As the metal ribbon having nano-crystalline structure, a Fe-based nano-crystal grain magnetic alloy may be used. In addition, as the Fe-based nano-crystal grain alloy, a Fe—Si—B—Cu—Nb alloy may be used. The Fe-based nano-crystalline alloy may have permeability of 20,000 before heat processing, but may have permeability of 100,000 after the heat processing.

Alternatively, the magnetic sheet may be formed of a semihard magnetic material. For example, the semihard magnetic material may be a Fe-based alloy, and may include nickel (Ni) in the range of 13 to 17%. In this case, coercivity of the magnetic sheet may be 1.5 to 3 kA/m, and remanence may be 1.3T to 1.6T.

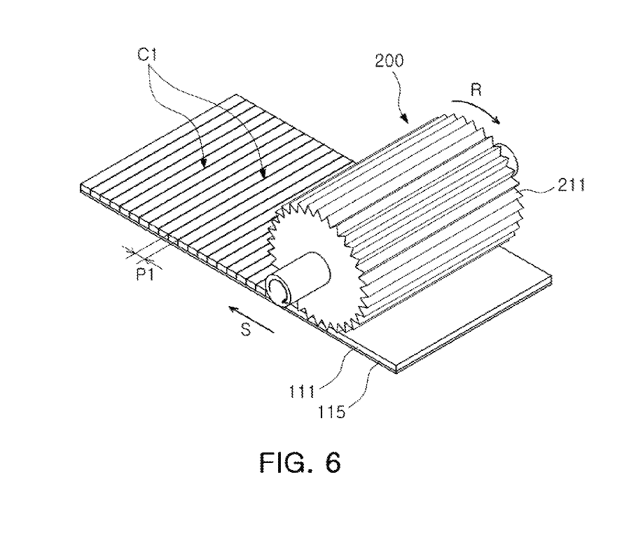

Hereinafter, the operation S501 (FIG. 5) of crushing the magnetic sheet will be described in more detail with reference to the process diagram of FIG. 6.

Referring to FIG. 6, the plurality of crack lines C1 arranged in one direction may be formed by applying a roller 200 having a plurality of protrusions 211 to the magnetic sheet 111. That is, the magnetic sheet 111 may be crushed in a form corresponding to the protrusions 211 by the plurality of protrusions 211 formed on the roller 200. Accordingly, the magnetic sheet 111 may be divided into a plurality of unit ribbons having the plurality of crack lines C1 as boundaries.

Specifically, the roller 200 may rotate R on a surface of the magnetic sheet 111, and the magnetic sheet 111 may be shifted S together with such a rotation R of the roller 200. For example, a direction in which the magnetic sheet 111 is shifted S and a direction in which the magnetic sheet is crushed to form the plurality of crack lines C1 may be perpendicular to each other. That is, the protrusions 211 of the roller 200 may be formed to be perpendicular to a direction in which the roller 200 rotates and moves. However, according to another example embodiment, the protrusions 211 of the roller 200 may also be formed to be parallel to the direction in which the roller 200 rotates and moves.

In addition, the plurality of crack lines C1 arranged in one direction may have a uniform pitch P1, that is, a uniform interval between adjacent lines C1. For example, the plurality of crack lines C1 may have the pitch of 1.25 mm or more and 5 mm or less. An interval between the plurality of crack lines C1 may determine an aspect ratio of the plurality of unit ribbons arranged on the magnetic sheet. For example, the aspect ratio of the plurality of unit ribbons may be 1:6 to 1:9. The aspect ratio of the plurality of unit ribbons will be described in more detail with reference to FIG. 11.

The plurality of crack lines C1 may divide the magnetic sheet 111 to provide magnetic shape anisotropy to the magnetic substance 110. In addition, the direction in which the plurality of crack lines are arranged may be parallel to an axis direction A (FIG. 3) of the solenoid coil included in the wireless communications antenna 100 (FIG. 3). Therefore, permeability of the magnetic substance 110 may be effectively adjusted by the plurality of crack lines C1 formed in the magnetic sheet 111.

Meanwhile, since the magnetic sheet 111 is divided by the plurality of crack lines C1 in the operation of crushing the magnetic sheet 111, an adhesive layer 115 may be formed on one surface of the magnetic sheet before the operation of crushing the magnetic sheet, in order to fix the divided magnetic sheet 111. The adhesive layer 115 may be an adhesive tape, and may also be formed by applying an adhesive or a resin having adhesive property to a surface of the magnetic sheet 111.

After the operation (S501 in FIG. 5) of crushing the magnetic sheet, the magnetic sheet 111 may be stacked in a plurality of layers (S502 in FIG. 5).

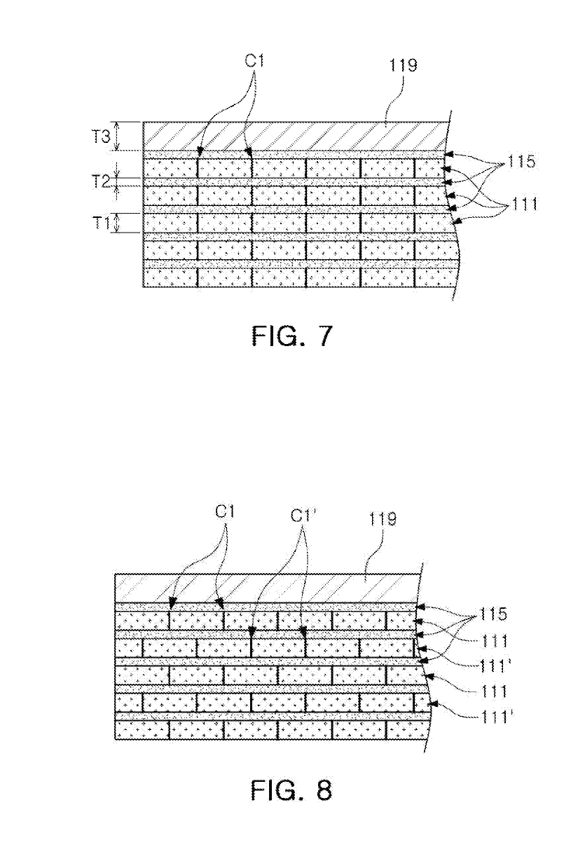

Referring to FIG. 7, a plurality of magnetic sheets 111 stacked in the plurality of layers may be confirmed.

In addition, in order to bond the plurality of magnetic sheets 111 to each other, the adhesive layer 115 may be disposed between the plurality of magnetic sheets 111. As described above, the adhesive layer 115 may be formed before the operation of crushing the magnetic sheet, and may be formed by applying the adhesive sheet, the adhesive, or the resin having adhesive property.

For example, one magnetic sheet 111 may have a thickness T1 of 10 μm to 200 μm, and one adhesive layer 115 may have a thickness T2 of 3 μm to 20 μm.

Meanwhile, the plurality of magnetic sheets 111 may have high permeability, and the adhesive layer 115 may have relatively low permeability. In this case, the magnetic field passing through the magnetic substance may be enhanced in the axis direction A (FIG. 3) of the solenoid coil in each of the magnetic sheets 111.

Although FIG. 7 illustrates a case in which five magnetic sheets 111 are stacked, the layers formed by the plurality of stacked magnetic sheets 111 may be varied. As the number of the stacked magnetic sheets 111 is increased, a cross-section area of the magnetic substance may be increased, and as the cross-section area of the magnetic substance is increased, magnetic resistance may be decreased. As a result, inductance of the wireless communications antenna 100 (FIG. 4) may be increased. In addition, as the inductance is increased, radiation characteristics of the wireless communications antenna may be improved. However, since the magnetic substance has a thickness limitation due to a limitation of a mounting space, the number of the layers formed by the plurality of stacked magnetic sheets may be selected in the range of 2 to 10.

According to an example embodiment, a resin layer 119 may be further stacked to form an outer layer of the plurality of stacked magnetic sheets 111. The resin layer 119 may form the outer layer of the magnetic substance 110 (FIG. 4) to determine reflectivity of the magnetic substance 110 for light. As described above, the wireless communications antenna 100 (FIG. 3) may be disposed below the display 12 (FIG. 2), and the resin layer 119 may keep the wireless communications antenna from being visible through the display. For example, the resin layer 119 may have a thickness T3 of 15 μm.

FIG. 8 is a cross-sectional view of a magnetic substance according to another example embodiment in the present disclosure. Referring to FIG. 8, the other magnetic sheet 111′ may be stacked to be adjacent to one magnetic sheet 111, and the plurality of crack lines C1 of the magnetic sheet 111 and crack lines C1′ of the adjacent stacked magnetic sheet 111′ may be arranged so as not to overlap each other (that is, arranged to be offset from each other). That is, in relation to the adhesive layer 115 bonding one magnetic sheet 111 and the adjacent magnetic sheet 111′, a first crack line C1 and a second crack line C1′ which are disposed on a top surface and a bottom surface of the adhesive layer 115 may be arranged to not intersect with each other.

As needed, one magnetic sheet 111 may simultaneously have the crack line C1 which overlaps the crack line C1′ of the magnetic sheet 111′ adjacent to the one magnetic sheet 111 and the crack line C1 which does not overlap crack line C1′ of the magnetic sheet 111′ adjacent to the one magnetic sheet 111.

By such a stacked structure, permeability of the magnetic substance may be further improved, and loss of the eddy current may be further reduced.

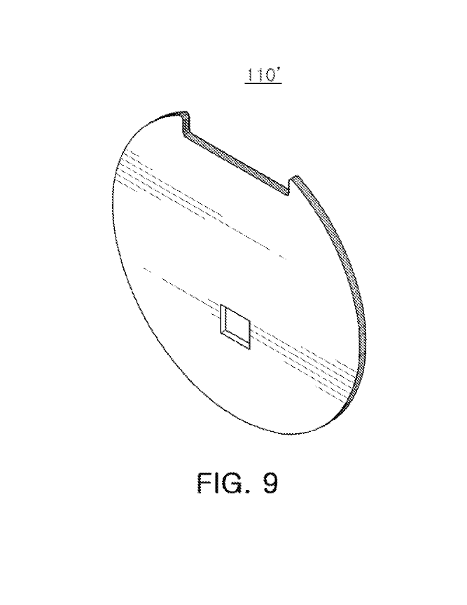

After the operation (S502 in FIG. 5) of stacking the magnetic sheet, the stacked magnetic sheet may be press-processed (S503 in FIG. 5). Referring to FIG. 9, the press-processed magnetic substance 110′ may be confirmed. For example, the magnetic substance 110′ may be prepared in an intended shape by a blanking operation. In addition, the magnetic substance 110′ may include a hole formed by a punching operation.

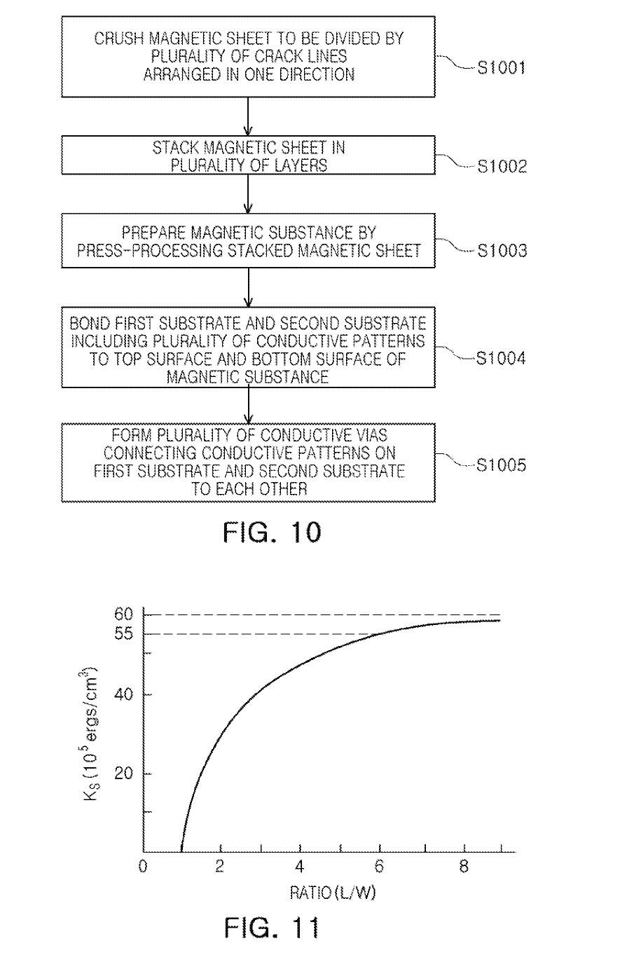

FIG. 10 is a flowchart illustrating a method of manufacturing a wireless communications antenna according to an example embodiment in the present disclosure. Since an operation (S1001) of crushing a magnetic sheet, an operation (S1002) of stacking the magnetic sheet, and an operation (S1003) of press-processing the magnetic sheet may be understood from the description described with reference to FIGS. 5 through 9, a detailed description thereof will be omitted.

After the magnetic substance is prepared through the operation (S1001) of crushing the magnetic sheet, the operation (S1002) of stacking the magnetic sheet, and the operation (S1003) of press-processing the magnetic sheet, a first substrate and a second substrate may be bonded to a top surface and a bottom surface of the magnetic substance (S1004).

Specifically, the magnetic substance 110 (FIG. 4) may be disposed between the first substrate 120 (FIG. 4) and the second substrate 130 (FIG. 4), and the first substrate 120 and the second substrate 130 may be compressed. In this case, the first substrate 120 and the second substrate 130 may each respectively be attached to the magnetic substance 110 by an adhesive sheet 104.

Meanwhile, before the operation of bonding the first substrate and the second substrate to the top surface and the bottom surface of the magnetic substance, a reinforcing layer 190 (FIG. 4) disposed between the first substrate and the second substrate may be formed at an outer portion of the magnetic substance. As illustrated in FIG. 4, the reinforcing layer may be disposed at a side portion of the magnetic substance 110. In addition, the reinforcing layer may be disposed to surround an outer edge of the magnetic substance 110 on the plan view of FIG. 3. For example, the reinforcing layer may be formed of a thermosetting resin having an insulating property and an adhesive property.

Next, a plurality of conductive vias connecting a plurality of conductive patterns on the first substrate and the second substrate to each other may be formed (S1005). Specifically, a through-hole penetrating through the first substrate and the second substrate may be formed, and an inner portion of the through-hole may be plated to form the plurality of conductive vias 150 (FIG. 4). In addition, in a case in which the reinforcing layer is disposed, the plurality of conductive vias may penetrate through the reinforcing layer.

Meanwhile, the plurality of conductive patterns on the first substrate and the second substrate may be formed after forming the plurality of conductive vias. Specifically, after the first substrate and the second substrate are bonded to the top surface and the bottom surface of the magnetic substance, and the plurality of conductive vias are formed in the first substrate and the second substrate bonded to the magnetic substance, the plurality of conductive patterns may be formed by a patterning operation for the first substrate and the second substrate. For example, the patterning operation may be performed by an exposing operation and a developing operation using a resist film.

FIG. 11 is a graph illustrating a relationship between a shape anisotropy constant and an aspect ratio of a unit ribbon. As described with reference to FIG. 6, the magnetic sheet 111 may be divided into the plurality of unit ribbons having the plurality of crack lines C1 as the boundaries, and the magnetic substance obtained through the press operation may include the plurality of unit ribbons.

The graph illustrated in FIG. 11 illustrates an experiment result of a case of a Co based magnetic alloy in which magnetic saturation of the unit ribbon is 1422 emu/cm³. A ratio (L/W) of FIG. 11 is of a length L of the unit ribbon to a width W of the unit ribbon. In an example, the width of the unit ribbon is determined by the pitch of the crack lines and the length of the unit ribbon is parallel to the crack lines.

Referring to FIG. 11, it may be seen that when an aspect ratio (W:L) of width to length is 1:6 or more, a shape anisotropic constant Ks arrives at 55 10⁵ ergs/cm³. In addition, when the aspect ratio is 1:9, the shape anisotropic constant Ks may arrive at a saturation value. Therefore, in order to have an appropriate shape anisotropic constant Ks, the plurality of unit ribbons according to an example embodiment may have the aspect ratio of 1:6 to 1:9.

As set forth above, according to the example embodiments in the present disclosure, the method capable of efficiently manufacturing the magnetic substance having improved permeability may be obtained. In addition, a miniaturized and thinned wireless communications antenna including such a magnetic substance and having improved radiation characteristics may be implemented.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of manufacturing a magnetic substance, the method comprising:
forming crack lines arranged in one direction on a magnetic sheet by crushing the magnetic sheet to divide the magnetic sheet by the crack lines;
stacking the magnetic sheet with other magnetic sheets into layers; and
press-processing the stacked magnetic sheets.

2. The method of claim 1, wherein:
the magnetic sheet is divided into unit ribbons by the crack lines; and
each of the unit ribbons has an aspect ratio of 1:6 to 1:9.

3. The method of claim 2, wherein the aspect ratio is an aspect ratio of a width to a length of each of the of unit ribbons.

4. The method of claim 1, wherein the crack lines have a pitch of 1.25 mm or more and 5 mm or less.

5. The method of claim 1, further comprising:
before the crushing of the magnetic sheet, forming an adhesive layer on one surface of the magnetic sheet.

6. The method of claim 1, wherein, in the stacking of the magnetic sheet, the magnetic sheet is stacked so that a crack line of the magnetic sheet overlaps a crack line of an adjacent magnetic sheet of the other magnetic sheets.

7. The method of claim 1, wherein, in the stacking of the magnetic sheet, the magnetic sheet is stacked so that a crack line of the magnetic sheet is offset from a crack line of an adjacent magnetic sheet of the other magnetic sheets.

8. The method of claim 1, wherein, in the stacking of the magnetic sheet, the magnetic sheet is stacked so that a crack line of the magnetic sheet overlaps a crack line of an adjacent magnetic sheet of the other magnetic sheets and another crack line of the magnetic sheet is offset from the crack line of the adjacent magnetic sheet.

9. The method of claim 1, wherein, in the crushing of the magnetic sheet, the crack lines are formed so that a pitch of the crack lines is uniform.

10. The method of claim 1, wherein, in the crushing of the magnetic sheet, the crack lines are formed by applying a roller having protrusions to the magnetic sheet.

11. The method of claim 10, wherein the protrusions of the roller are formed linearly to be perpendicular to a direction in which the roller moves.

12. The method of claim 11, wherein the protrusions of the roller are formed parallel to an axis of rotation of the roller.

13. The method of claim 1, further comprising:
stacking a resin layer to form an outer layer of the stacked magnetic sheets.

14. A method of manufacturing a wireless communications antenna, the method comprising:
forming crack lines arranged in one direction on a magnetic sheet by crushing the magnetic sheet to divide the magnetic sheet by crack lines;
stacking the magnetic sheet with other magnetic sheets into layers;
press-processing the stacked magnetic sheets;
bonding a first substrate to a top surface of the stacked magnetic sheets and a second substrate to a bottom surface of the stacked magnetic sheets; and
forming conductive vias configured to connect conductive patterns on the first substrate with conductive patterns on the second substrate.

15. The method of claim 14, wherein, in the stacking of the magnetic sheet, the magnetic sheet is stacked so that the crack lines of the magnetic sheet overlap crack lines of an adjacent magnetic sheet of the other magnetic sheets.

16. The method of claim 14, wherein, in the stacking of the magnetic sheet, the magnetic sheet is stacked so that crack lines of the magnetic sheet are offset from crack lines of an adjacent stacked magnetic sheet of the other magnetic sheets.

17. The method of claim 14, wherein the crack lines have a pitch of 1.25 mm or more and 5 mm or less.

18. The method of claim 14, wherein
the conductive patterns and the conductive vias form a solenoid coil, and
the one direction is parallel to an axis of the solenoid coil.

19. The method of claim 14, further comprising:
forming a reinforcing layer disposed between the first substrate and the second substrate, at an outer portion of the stacked magnetic sheets.

20. The method of claim 14, further comprising:
stacking a resin layer to form an outer layer of the stacked magnetic sheets.
